(19) United States
(12) Patent Application Publication
(10) Pub. No.: US 2007/0008816 A1
(43) Pub. Date: Jan. 11, 2007

(54) MIXER

(75) Inventor: Youjun Dai, Nanjing (CN)

Correspondence Address: WALLENSTEIN & WAGNER, LTD., 311 SOUTH WACKER DRIVE, 53RD FLOOR, CHICAGO, IL, 60606, US

(73) Assignee: NANJING CHERVON INDUSTRY CO., LTD., Nanjing (CN)

(21) Appl. No.: 11/428,922

(22) Filed: Jul. 6, 2006

(30) Foreign Application Priority Data
Jul. 8, 2005 (CN) 200520073450.X

(51) Int. Cl. B01F 7/18

(52) U.S. Cl. 366/207

(57) ABSTRACT

To achieve the above-mentioned object, the present invention provides a mixer which comprises a body connecting with a supporting rod, a power system located within the body for driving a mixing paddle to rotate for mixing, and a lifting system for adjusting the location of the body on the supporting rod. The supporting rod comprising a set of teeth distributed on the supporting rod in an axial direction, the lifting system comprising a handle and a gear which is operable with the handle and engaged with the teeth, the body being at a fixed location with respect to the teeth or gear and a lifting system with a lift-locking means having a first member and a second member engaged with each other to limit rotation of the gear.

### CROSS-REFERENCE TO RELATED APPLICATIONS

This application claims priority to Chinese Application No. 200520073450.X, filed on Jul. 8, 2005, the entire disclosure of which is incorporated herein by reference. Priority to this application is claimed under 35 U.S.C. 119, 120 and/or 365.

### FEDERALLY SPONSORED RESEARCH OR DEVELOPMENT

None.

### TECHNICAL FIELD

The invention relates to a lifting system for a body of a mixer.

### BACKGROUND OF THE INVENTION

A mixer generally includes a mixing paddle to be put into a mixing barrel for mixing and homogenizing the substance to be mixed such as grout and the like. A power system is provided in the body of the mixer which is connected with a fixed support and is located over the barrel so as to drive the mixing paddle to rotate, which is often comprised of a power supply, a baric or hydraulic motor and a driving system.

When a mixing operation is finished, it is necessary to move the mixing paddle out of the barrel and pour away the substance therein. For this reason, the mixing paddle may be drawn out of the barrel by lifting the mixer body so that the barrel may be removed easily. For this reason, a mixer with a fixed support along with a lifting system for the body is typically required.

In existing mixers, a lifting operation occurs by the body sliding along a supporting rod of the fixed support and a bolt locks the body in place. In other mixers the lifting operation is accomplished through a spring ejecting the body while a cam mechanism locks the body in place. However, the first method is very difficult to operate and for the second method, after the cam mechanism is released, the spring force tends to suddenly eject the body which may hurt the operator and additionally create a large pressure once the body has fallen. Another disadvantage of existing mixers is that it is difficult to complete the height adjustment by one hand.

The present invention is provided to solve these and other problems.

### SUMMARY OF THE INVENTION

An object of the invention is to provide a mixer with an improved lifting system which can be operated by a single hand. The lifting system allows an operator to easily adjust the height of the mixer body.

To achieve the above-mentioned object, the present invention provides a mixer which comprises a body connected by a supporting rod to a fixed support. A power system is located within the body for driving a mixing paddle to rotate for mixing the desired substance, and a lifting system for adjusting the location of the body on the supporting rod. The supporting rod includes a set of teeth distributed on the supporting rod in an axial direction. The lifting system also includes a handle and a gear which is operable with the handle and engaged with the teeth. The body is positioned at a fixed location with respect to the teeth or gear and the lifting system has a lift-locking assembly with a first member and a second member engaged with each other to limit rotation of the gear.

Another object of the invention is to provide a mixer with a lifting system which can be locked automatically. To achieve the automatic locking object, the first member of the lift-locking assembly is fixed on the fixed support and the second member is engaged with the gear. The lift-locking assembly further includes a spring which produces a predetermined force pressing tightly the second member onto the first member. The engaging surface of the first member and the second member is formed by oblique teeth.

Accordingly, a mixer with a lifting system of the present invention allows the body to be locked automatically at any location.

Other features and advantages of the invention will be apparent from the following specification taken in conjunction with the following drawings.

### BRIEF DESCRIPTION OF THE DRAWINGS

The various embodiments according to the present invention will be further described in detail combined with the figures hereinafter.

FIG. 1 is a perspective view showing the present invention as a whole.

FIG. 2 is a partial cross sectional view of the lifting system in FIG. 1.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

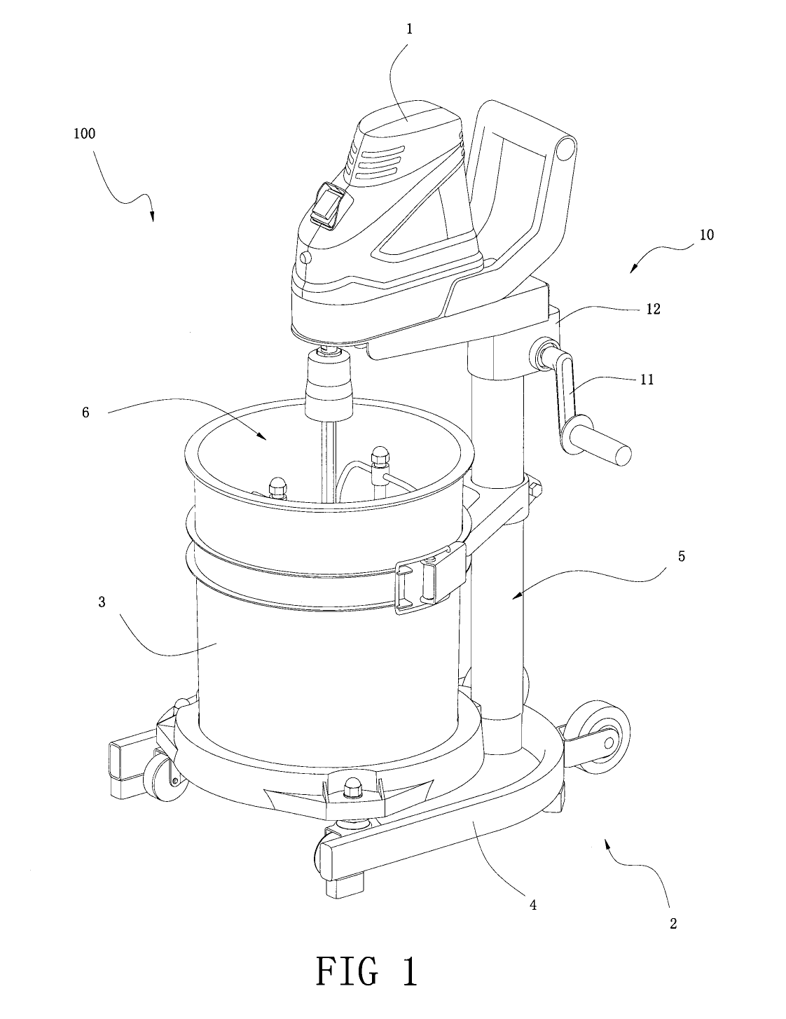

As shown in FIG. 1, a mixer 100 generally comprises a mixing paddle 6 which is put into a barrel 3 to mix and homogenize the substance to be mixed such as grout and the like. A body 1 is connected with a supporting rod 5 to a fixed support 2 and is located over the barrel 3. The fixed support 2 further includes a base 4 for placing the barrel 3 thereon. A power system (not shown) comprised of a motor and a driving system is provided within the body 1 for driving the mixing paddle 6 to rotate. A lifting system 10 is provided at the back end of body 1 connecting with the supporting rod 5, which is used for adjusting the height of the body 1 with respect to the supporting rod 5 or the base 4. The lifting system 10 further comprises a bracket 12, and a handle 11 for performing the height adjustment.

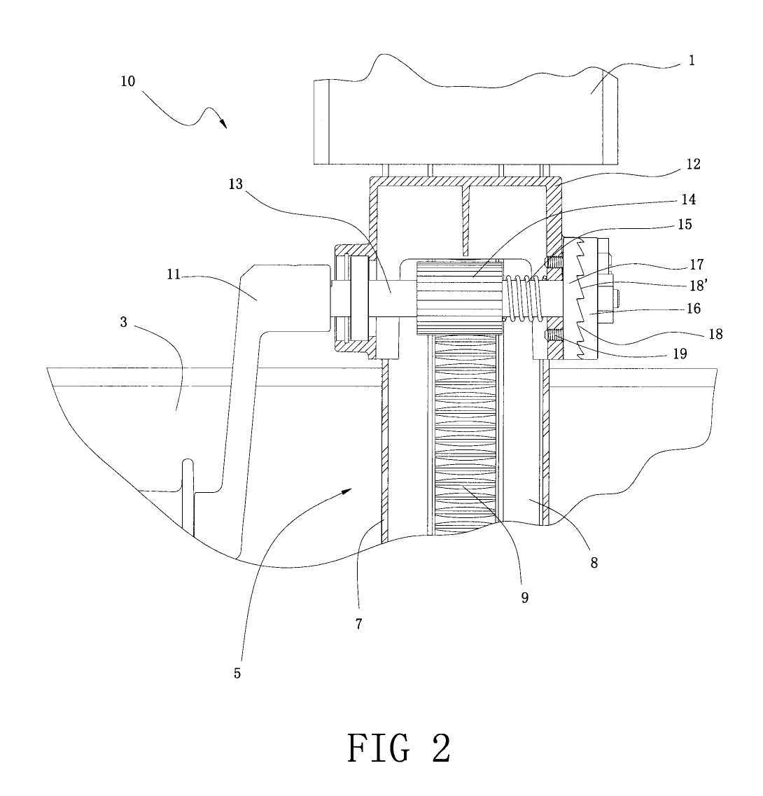

FIG. 2 is a schematic view of one embodiment of the lifting system 10 in which the bracket 12 and the supporting rod 5 are sectioned partially. As shown in FIG. 2, in this embodiment, the supporting rod 5 is comprised of a rod sleeve 7 fixed on the base 4 and a sliding rod 8 connected fixedly to the body 1 and may slide freely with respect to the rod sleeve 7. The sliding rod 8 is provided with a set of axial teeth 9.

The bracket 12 of the lifting system 10 is fixed on the rod sleeve 7, and a rotating shaft 13 traverses the bracket 12 in a perpendicular direction to the supporting rod 5. One end of the driving shaft 13 is connected to the handle 11, and the other end is connected to a first locking block 16 with oblique teeth 18. A gear 14 on the driving shaft 13 engages with the axial teeth 9 on the sliding rod 8. A spring 15 is at one end of the gear 14 near the first locking block 16 and between the gear 14 and the bracket 12. A second locking block 17 is fixed onto the bracket 12 by bolts 19 and may contact the first locking block 16 by at least a portion of the surfaces thereof. The second locking block 17 is provided with oblique teeth 18′ which are engaged with the oblique teeth 18 of the first locking block 16. When the lifting system 10 is in a normal state without any external force, the spring 15 produces a spring force to make the first locking block 16 and the second locking block 17 abut tightly. At the same time, the oblique teeth 18, 18′ of the first locking block 16 and the second locking block 17 prevent the first locking block 16 from rotating with the gear 14. For example, in the embodiment shown in FIG. 2, as the gear 14 is at a fixed location, the sliding rod 8 and the body 1 tend to move downward due to gravity, hence the axial teeth 9 apply force to the gear 14 so that the gear 14 tends to rotate in clockwise direction (see from the right end of the driving shaft 13), however the engaged oblique teeth 18, 18′ of the first and second locking blocks 16, 17 prevent the movement trend in the direction shown in FIG. 2.

To adjust the height of the body 1, the operator only needs to hold the handle 11, and apply a push force in the direction of the driving shaft 13 (i.e., along a longitudinal axis running through the driving shaft 13 and substantially perpendicular to the rod sleeve 7) to make the first locking block 16 disengage with the second locking block 17, then rotate the handle 11 to drive the gear 14 to rotate and thereby to lift or lower the body 1 together with the sliding rod 8. After the body reaches the desired height, the handle 11 is released. The first locking block 16 and the second locking block 17 return into the engagement state again due to the action of spring 15 so as to obtain the locking function. In this instance, functions of the oblique teeth 18, 18′ become especially apparent: the tooth tips will slide into the tooth sockets to fit tightly, even if the tooth tips are not directly opposite to the tooth sockets.

The preferred embodiment of the present invention is illustrated in the above description and drawings. But the invention is not limited to this embodiment. For example, the body 1 may be fixed with respect to the bracket 12, the gear 14 moves along the axial teeth 9 up and down to drive the body 1 to be lifted or lowered, while the supporting rod 5 may include only a fixed rod with teeth on the surface. In the lifting system 10, the spring 15 is not necessary, and the mixer 100 may also achieve the objects of the invention without the spring 15. Furthermore, the location and the force applied of spring 15 in the present invention may be varied. When not applied by any manually external force, the spring 15 in this system may be tensed or compressed, may be located at any end of the gear 14 on the driving shaft 13 or at any other location, as long as the force produced by the spring 15 can make the first locking block 16 press onto the second locking block 17, while the action force may be withdrawn by the manually external force so that the first and the second lock members 16, 17 may release from engagement. Otherwise, the engagement between the first lock member 16 and the second lock member 17 do not depend on the oblique teeth 18, 18′ alone, it may include other means such as projections or grooves and the like.

While the specific embodiments have been illustrated and described, numerous modifications come to mind without significantly departing from the spirit of the invention, and the scope of protection is only limited by the scope of the accompanying Claims.

What is claimed is:

1. A mixer comprising:
a body;
a motor positioned inside the body;
a mixing paddle operably connected to the motor;
a lifting assembly operably connected to the body, the lifting assembly comprising a sleeve, a sliding member having axial teeth, and a handle operably connected to a rotating shaft having a gear that cooperates with the axial teeth of the inner sliding member to raise and lower the body by turning the handle and rotating the rotating shaft.

2. The mixer of claim 1 further comprising a fixed support connected to the lifting assembly, the fixed support having a base for placing a container thereon.

3. The mixer of claim 1 further comprising a fixed support member extending from a base, wherein one end of the sliding member is connected to the body and another end of the sliding member is connected to the fixed support member.

4. The mixer of claim 1 further comprising a bracket that encloses the connection between the gear of the rotating shaft and the axial teeth of the inner sliding member.

5. The mixer of claim 4, wherein the bracket is connected to the body.

6. The mixer of claim 1, wherein the sleeve is connected to a base and the sliding member is connected to the body, the sliding member being able to move freely with respect to the sleeve.

7. The mixer of claim 1 further comprising means for locking the sliding member in a fixed position.

8. The mixer of claim 4 further comprising a first locking member connected to one end of the rotating shaft and a second locking member connected to the bracket.

9. The mixer of claim 8, wherein the first locking member has a plurality of teeth that engage a plurality of teeth formed in the second locking member.

10. The mixer of claim 9 further comprising a spring that applies a force that urges the first locking member into engagement with the second locking member.

11. The mixer of claim 10, wherein a force applied along an axis aligned with the rotating shaft forces the first locking member out of engagement with the second locking member.

12. A mixer for mixing a desired substance in a container, comprising:
a fixed support having a base for supporting the container and a support member;
a lift system operably connected at one end to the support member;
a body housing a motor connected to a second end of the lift system;
a mixing paddle operably connected to the motor, wherein the lift system is comprised of:
a sliding rod having teeth formed therein, the sliding rod connected at one end to the support member; and
a handle connected to one end of a shaft having first and second ends and a gear, the gear connected to the sliding rod via the teeth such that when the handle is turned, the shaft rotates the gear and moves the sliding rod one of either away from or towards the base.

13. The mixer of claim 12 further comprising a locking system that keeps the sliding rod in a fixed position.

14. The mixer of claim 13, wherein the locking system comprises first and second locking members and a biasing member.

15. The mixer of claim 14, wherein the biasing member is a spring, which has a first and a second position, in the first position the spring applies a force to urge the first and second locking members together and in the second position wherein an external force is applied to the spring, the spring urges the first and second locking members apart.

16. The mixer of claim 12 further comprising a bracket for housing the connection between the gear and the teeth of the sliding rod.

17. The mixer of claim 16 further comprising a first locking block having a plurality of oblique teeth connected to one end of the shaft and a second locking block having a plurality of corresponding oblique teeth, the second locking block fixedly connected to the bracket.

18. The mixer of claim 12, wherein the lifting system further comprises a locking assembly having a spring which produces a predetermined force to urge one end of the shaft into engagement with a fixed locking member to prevent the shaft from rotating.

19. The mixer of claim 18, wherein an operator of the mixer can apply an external force to the spring by pushing the handle in a direction along a longitudinal axis of the shaft to disengage the one end of the shaft from the fixed locking member.

20. The mixer of claim 12 further comprising means for locking the shaft so that the sliding rod and body are in a fixed position.
